(19) United States
(12) Patent Application Publication
(10) Pub. No.: US 2025/0360828 A1
(43) Pub. Date: Nov. 27, 2025

(54) CHARGE CONTROL DEVICE AND CHARGE CONTROL METHOD

(71) Applicant: JVCKENWOOD Corporation, Yokohama-shi (JP)

(72) Inventor: Ryuichi OKAZAKI, Yokohama-shi (JP)

(21) Appl. No.: 19/294,835

(22) Filed: Aug. 8, 2025

Related U.S. Application Data
(63) Continuation of application No. PCT/JP2024/004367, filed on Feb. 8, 2024.

(30) Foreign Application Priority Data
Feb. 10, 2023 (JP) 2023-019211
Feb. 10, 2023 (JP) 2023-019221

(51) Int. Cl. B60L 53/62; B60L 53/30; B60L 53/53; B60L 58/10

(52) U.S. Cl. CPC B60L 53/62; B60L 53/32; B60L 53/53; B60L 58/10; B60L 2260/52; B60L 2260/54; B60L 2260/58

(57) ABSTRACT

A battery information acquisition unit acquires a charging status of a battery of a portable electric power source, the portable electric power source being mounted on a vehicle for which a destination is set. A vehicle information acquisition unit acquires at least a piece of information regarding the vehicle electric power source included in the vehicle. An electric energy supply amount calculator calculates an electric energy supply y amount that can be supplied from the vehicle electric power source to the portable electric power source without hindering the vehicle from traveling to the destination. A charge command unit commands the charge controller to charge the battery by supplying electric power from the vehicle electric power source to the battery with the electric energy amount equal to or less than the electric energy supply amount when it determines charging of the battery is necessary based on the charging status of the battery.

### CROSS-REFERENCE TO RELATED APPLICATIONS

This application is a continuation of PCT Application No. PCT/JP2024/004367, filed on Feb. 8, 2024, and claims the priority of Japanese Patent Applications No. 2023-019211 and No. 2023-019221, filed on Feb. 10, 2023, the entire contents of all of which are incorporated herein by reference.

### BACKGROUND

The present disclosure relates to a charge control device, a charge control method, and a charge control program.

A portable electric power source used for outdoor activities, such as camping, may be loaded on a vehicle when setting out for outdoor activities.

### SUMMARY

There are cases where a portable electric power source is not charged, or is not fully charged, when the portable electric power source is loaded on a vehicle. It is desirable to develop a charge control device, a charge control method, and a charge control program, each of which can automatically charge a portable electric power source, without a user having to worry about managing the charge amount even in such cases.

A first aspect of one or more embodiments provides a charge control device including: a battery information acquisition unit configured to acquire a charging status of a battery of a portable electric power source from the portable electric power source, the portable electric power source being mounted on a vehicle for which a destination is set; a vehicle information acquisition unit configured to acquire at least a piece of information regarding the vehicle electric power source included in the vehicle; an electric energy supply amount calculator configured to calculate, based on the information acquired by the vehicle information acquisition unit, an electric energy supply amount that can be supplied from the vehicle electric power source to the portable electric power source without hindering the vehicle from traveling to the destination; and a charge command unit configured to command the charge controller included in the portable electric power source to charge the battery by supplying electric power from the vehicle electric power source to the battery with an electric energy amount equal to or less than the electric energy supply amount when determining charging of the battery is necessary based on the charging status of the battery acquired from the battery information acquisition unit.

A second aspect of one or more embodiments provides a charge control method including: acquiring a charging status of a battery of a portable electric power source from the portable electric power source, the portable electric power source being mounted on a vehicle for which a destination is set; acquiring at least a piece of information regarding the vehicle electric power source included in the vehicle; calculating, based on the acquired information, an electric energy supply amount that can be supplied from the vehicle electric power source to the portable electric power source without hindering the vehicle from traveling to the destination; and commanding the charge controller included in the portable electric power source to charge the battery by supplying electric power from the vehicle electric power source to the battery with an electric energy amount equal to or less than the electric energy supply amount when determining that charging of the battery is necessary based on the acquired charging status of the battery.

A third aspect of one or more embodiments provides a charge control device including: a schedule acquisition unit configured to acquire a user's schedule; a battery information acquisition unit configured to acquire a charging status of a battery of a portable electric power source from the portable electric power source, the portable electric power source being mounted on a vehicle for which a destination is set; and a charge command unit configured to command the charge controller included in the portable electric power source to charge the battery by supplying electric power from the vehicle electric power source included in the vehicle when determining that charging of the battery is necessary, based on the charging status of the battery acquired by the battery information acquisition unit, when use of the portable electric power source is set, or when an event with a possibility of using the portable electric power source is set based on the schedule acquired by the schedule acquisition unit.

### BRIEF DESCRIPTION OF THE DRAWINGS

FIG. 1 is a block diagram illustrating a charge control device according to a first embodiment.

FIG. 2 is a block diagram illustrating a modification of a charge control device according to a first embodiment.

FIG. 3 is a flowchart illustrating an operation of a charge control device according to a first embodiment, a charge control method according to a first embodiment, and a process which a charge control program according to a first embodiment causes a computer to execute.

FIG. 4 is a block diagram illustrating a charge control device according to a second embodiment.

FIG. 5A is a diagram illustrating a first example of a user schedule.

FIG. 5B is a diagram illustrating a second example of a user schedule.

FIG. 6 is a block diagram illustrating a modification of a charge control device according to a second embodiment.

FIG. 7 is a flowchart illustrating an operation of a charge control device according to a second embodiment, a charge control method according to a second embodiment, and a process which a charge control program according to a second embodiment causes a computer to execute.

### DETAILED DESCRIPTION

A charge control device, a charge control method, and a charge control program according to each embodiment will be described below with reference to the accompanying drawings.

### First Embodiment

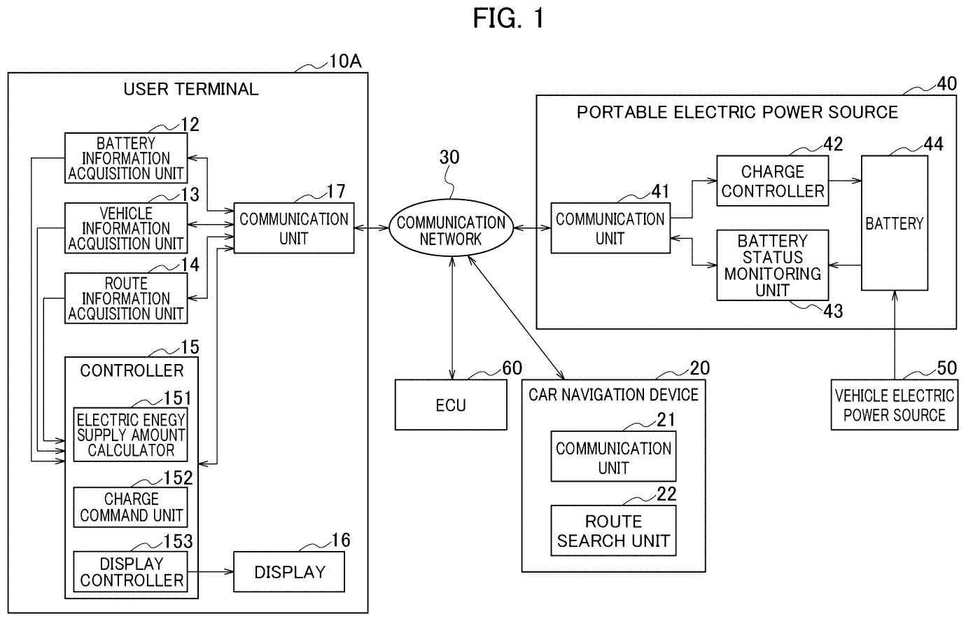

In FIG. 1, a user terminal 10A communicates with a car navigation system 20, a portable electric power source 40, and an electronic controller (ECU) 60 through a communication network 30. The ECU 60 is provided in a vehicle. The ECU 60 may be connected to the communication network 30 via a controller area network (CAN) bus. There may be multiple ECUs 60. The communication network 30 may be a cellular telephone communication network, a wireless LAN, or Bluetooth (registered trademark). The wireless LAN may be Wi-Fi, which complies with the IEEE 802.11 standard. The communication network 30 is not limited to a wireless communication network, and may be a wired communication network.

The user terminal 10A functions as a charge control device according to a first embodiment. The user terminal 10A may be configured by a personal computer, a tablet device, or a smartphone. The user terminal 10A includes a battery information acquisition unit 12, a vehicle information acquisition unit 13, a route information acquisition unit 14, a controller 15, a display 16, and a communication unit 17. The controller 15 includes an electric energy supply amount calculator 151, a charge command unit 152, and a display controller 153. A car navigation device 20 includes a communication unit 21 and a route search unit 22. The car navigation device 20 is installed in the vehicle.

The portable electric power source 40 includes a communication unit 41, a charge controller 42, a battery status monitoring unit 43, and a battery 44. The vehicle includes an outlet into which plugs from electronic equipment or electrical equipment are inserted. The portable electric power source 40 is placed at any position in a trunk, or the like, of the vehicle, and a plug of the portable electric power source 40 can be inserted into the outlet. With the portable electric power source 40 connected to a vehicle electric power source 50 by inserting the plug of the portable electric power source 40 into the outlet, the battery 44 may be charged with electric power supplied from the vehicle electric power source 50.

The portable electric power source 40 may be connected to a cigarette lighter socket included in a vehicle having a cigarette lighter plug. In this case, the battery 44 may be charged with electric power that is supplied from the vehicle electric power source 50 while the portable electric power source 40 is connected to the vehicle electric power source 50 by inserting the cigarette lighter plug into the cigarette lighter socket.

The vehicle electric power source 50 is a battery for driving an electric vehicle (known as battery EV) in which a vehicle travels by powering a motor with electric power charged in the battery for driving. In a case of an automobile that runs on an engine, the vehicle electric power source 50 refers to a generator installed in the vehicle. In the case of an automobile that runs on an engine, the vehicle electric power source 50 may be a battery that stores electric power generated by the generator.

In the user terminal 10A, the battery information acquisition unit 12 acquires a charging status of the battery 44 from the portable electric power source 40 through the communication unit 17 and the communication network 30. The battery information acquisition unit 12 may be configured to acquire the charging status of the battery 44 when a destination of the vehicle is set in the car navigation device 20 and the route information acquisition unit 14 acquires the route information searched by the route search unit 22.

In the portable electric power source 40, the battery status monitoring unit 43 monitors a status of the battery 44. The status of the battery 44 refers to a charging status of the battery 44. The battery information acquisition unit 12 acquires the status of the battery 44 from the battery status monitoring unit 43 through the communication unit 41, the communication network 30, and the communication unit 17. The battery information acquisition unit 12 may acquire the status of the battery 44 from the battery status monitoring unit 43 at an appropriate timing, or may acquire the status of the battery 44 at predetermined time internals.

The vehicle information acquisition unit 13 acquires at least a piece of information regarding a vehicle electric power source included in a vehicle from the ECU 60. The information regarding the vehicle electric power source refers to electric power supply information of the vehicle. The electric power supply information includes the electric energy amount that can be output by the vehicle electric power source 50. The electric energy amount that can be output by the vehicle electric power source 50 may be an amount of electric current and a voltage value output by the vehicle electric power source 50. When the vehicle is an electric vehicle or plug-in hybrid vehicle, the electric power supply information includes a capacity of a battery for driving, and a remaining charge amount of the battery for driving included in the electric vehicle or plug-in hybrid vehicle. When the vehicle is an automobile running on an engine, the electric power supply information is the electric energy amount per unit time that can be generated by power generation by a generator.

Instead of acquiring the electric power supply information from the ECU 60, the vehicle information acquisition unit 13 may refer to a database that holds the electric power supply information corresponding to the type of the vehicle, and may acquire some of the electric power supply information by a user selecting any piece of the electric power supply information. The vehicle information acquisition unit 13 may refer to the database that holds the electric power supply information corresponding to the type of the vehicle to acquire vehicle-specific information, such as a battery capacity of a battery for driving an electric vehicle or a plug-in hybrid vehicle, and the electric energy amount per unit time that can be generated by power generation using a generator of an automobile running on an engine.

The vehicle information acquisition unit 13 may acquire a piece of information regarding traveling of a vehicle in addition to the piece of information regarding the vehicle electric power source. The information regarding the traveling of a vehicle may be a traveling speed of a vehicle, or a type of road as to whether the vehicle is traveling on an expressway or a public road. The traveling speed of a vehicle may be an average speed during a predetermined time period. In addition to the piece of information regarding the vehicle electric power source, the vehicle information acquisition unit 13 may acquire information regarding the use of an electric power consumption device in the vehicle, such as an air conditioner or a car audio. In addition to the piece of information regarding the vehicle electric power source, the vehicle information acquisition unit 13 may acquire both pieces of information regarding the traveling of the vehicle and regarding the use of an electric power consumption device. The vehicle information acquisition unit 13 may acquire at least one of a piece of information regarding the traveling of the vehicle or a piece of information regarding the use of an electric power consumption device.

The route information acquisition unit 14 acquires route information searched by the route search unit 22 through the communication network 30 and the communication unit 17. The route information includes a time required for a vehicle to arrive at a destination, and the route information acquisition unit 14 acquires a time required for a vehicle to arrive at a destination. The route information acquisition unit 14 may acquire only a time required for a vehicle to arrive at a destination using the car navigation system 20. Instead of the vehicle information acquisition unit 13 acquiring the type of road as to whether the vehicle is traveling on an expressway or a public road, the route information acquisition unit 14 may acquire the type of road.

The charging status of the battery 44 acquired by the battery information acquisition unit 12, at least a piece of information regarding the vehicle electric power source acquired by the vehicle information acquisition unit 13, and a piece of route information acquired by the route information acquisition unit 14, are input to the controller 15. The electric energy supply amount calculator 151 calculates the electric energy amount that can be supplied from the vehicle electric power source 50 to the portable electric power source 40, based on an electric energy supply amount that the vehicle electric power source 50 can output, and a time required for a vehicle to arrive at a destination. The electric energy supply amount that can be supplied from the vehicle electric power source 50 to the portable electric power source 40 refers to an electric energy amount that can be supplied to the portable electric power source 40 without hindering the vehicle from traveling to the destination.

When the vehicle is an electric vehicle, the electric energy amount that can be output from the vehicle electric power source 50 refers to a remaining charge amount of the battery for driving. Therefore, the electric energy supply amount that can be supplied from the vehicle electric power source 50 to the portable electric power source 40 refers to electric energy amount obtained by subtracting the required electric energy amount for a vehicle to reach a destination from the remaining charge amount of the battery for driving. When the vehicle is an automobile that runs on an engine, the electric energy amount that can be output from the vehicle electric power source 50 refers to electric energy amount that can be supplied by the generator. The electric energy supply amount that can be supplied from the vehicle electric power source 50 to the portable electric power source 40 refers to an electric energy amount obtained by subtracting the required electric energy amount for the vehicle to travel from the electric energy amount that can be supplied by the generator. In this case, the electric energy amount per unit time may be used.

When a vehicle is an electric vehicle, the electric power cost of the electric vehicle affects the required electric energy amount for the vehicle to reach a destination. Therefore, at least a piece of information regarding traveling of the vehicle or a piece of information regarding the use of an electric power consumption device in the vehicle is preferably input to the electric energy supply amount calculator 151. More preferably, both pieces of information are input to the electric energy supply amount calculator 151. The electric energy supply amount calculator 151 preferably calculates the electric energy supply amount based on the piece of information regarding the vehicle electric power source, and based on at least a piece of information regarding traveling of the vehicle or a piece of information regarding the use of the electric power consumption device, or preferably based on both pieces of information.

The charge command unit 152 determines whether charging of the battery 44 is necessary based on the charging status of the battery 44 acquired from the battery information acquisition unit 12. When the charge command unit 152 determines that charging of the battery 44 is necessary, it commands the charge controller 42 to start charging the battery 44 through the communication unit 17, the communication network 30, and the communication unit 41. At this point, the charge command unit 152 commands the charge controller 42 to charge the battery 44 by supplying electric power from the vehicle electric power source 50 to the battery 44 of the portable electric power source 40, with an electric energy amount equal to or less than the electric energy supply amount calculated by the electric energy supply amount calculator 151.

The charge command unit 152 may determine that charging of the battery 44 is necessary when the battery 44 is not fully charged, or that charging of the battery 44 is necessary when a charge amount of the battery 44 is equal to or less than a predetermined amount of charge.

Thus, the charge command unit 152 determines whether charging of the battery 44 is necessary based on a charging status of the battery 44 obtained by the battery information acquisition unit 12. When it determines that charging of the battery 44 is necessary, the charge command unit 152 commands the charge controller 42 to charge the battery 44 by supplying electric power from the vehicle electric power source 50 to the battery 44 through the communication unit 17, the communication network 30, and the communication unit 41.

The charge command unit 152 preferably calculates the required electric energy amount by the portable electric power source 40 at a destination based on information of a device that is connected to the portable electric power source 40, and is operating with electric power supplied from the portable electric power source 40. The charge command unit 152 may command the portable electric power source 40 to charge the battery 44 to at least satisfy the required electric energy amount when it is determined that an amount of charge of the battery 44 is less than the required electric energy amount based on the charging status of the battery 44 acquired by the battery information acquisition unit 12. The charge command unit 152 may command the portable electric power source 40 to fully charge the battery 44 as long as the battery 44 can be charged at or below the electric energy supply amount.

The charge command unit 152 preferably commands the charge controller 42 to charge the battery at a charging speed corresponding to a time required for a vehicle to arrive at the destination so that the charging speed for charging the battery 44 becomes slower as the time required for a vehicle to arrive at a destination increases, and the charging speed becomes faster as the time required for a vehicle to arrive at a destination decreases. The charge command unit 152 preferably commands the charge controller 42 to charge the battery 44 at at least two charging speeds according to the time required for a vehicle to arrive at a destination. The charge command unit 152 may continuously change the charging speed according to the time required for a vehicle to arrive at a destination, and command the charge controller 42 to charge the battery at the charging speed most suitable for the time required for a vehicle to arrive at a destination.

In this manner, when the time required for a vehicle to arrive at a destination is long, the charging speed of the battery 44 is reduced so that the battery 44 is not charged rapidly, thus reducing deterioration of the battery 44. In addition, the charging speed of the battery 44 is reduced, thereby reducing electric energy amount per unit time supplied from the vehicle electric power source 50 to the battery 44, so that traveling of the vehicle can be less affected even if the required electric energy amount for the vehicle to travel increases abruptly for some reason. When the time required for the vehicle to arrive at a destination changes due to the presence or absence of a traffic jam, the charging speed may change in accordance with the change in the time required for a vehicle to arrive at the destination.

When the charge command unit 152 commands the charge controller 42 to charge the battery 44, the display controller 153 controls the display 16 to display text or an image to notify a user that charging of the battery 44 has started. The display 16 and the display controller 153 are examples of notification units. Alternatively, or in addition to displaying text or an image to notify the user that charging of the battery 44 has started, the display 16 may notify the user by a voice emitted from a speaker that charging of the battery 44 has started. The speaker and a voice generation controller are other examples of notification units.

The charge controller 42 controls the battery 44 to be charged by the electric power supplied from the vehicle electric power source 50 upon receiving a command to start charging. When the battery information acquisition unit 12 determines that the charging of the battery 44 is completed based on the status of the battery 44 acquired from the battery status monitoring unit 43, it notifies the controller 15 that the charging of the battery 44 is completed. The charge command unit 152 commands the charge controller 42 to terminate charging. When the charge command unit 152 commands the charge controller 42 to terminate charging of the battery 44, the display controller 153 controls the display 16 to display text or an image to notify the user that the charging of the battery 44 is completed.

As described above, according to the user terminal 10A functioning as a charge control device, the portable electric power source 40 can be automatically charged when the portable electric power source 40 mounted on the vehicle is not charged or is not fully charged.

The battery information acquisition unit 12, the vehicle information acquisition unit 13, and the route information acquisition unit 14 for the user terminal 10A may be provided in the controller 15. The controller 15 may configured by a central processing unit (CPU) of a microcomputer. At least the electric energy supply amount calculator 151 or the charge command unit 152 may be implemented as functions by the CPU executing a charge control program which is a computer program. The battery information acquisition unit 12, the vehicle information acquisition unit the route information acquisition unit 14, the electric energy supply amount calculator 151, the charge command unit 152, and the display controller 153 may be implemented as functions by the CPU executing the charge control program which is the computer program. The charge control program is stored in a non-transitory storage medium provided in the user terminal 10A, and the CPU executes the charge control program.

### Modification of First Embodiment

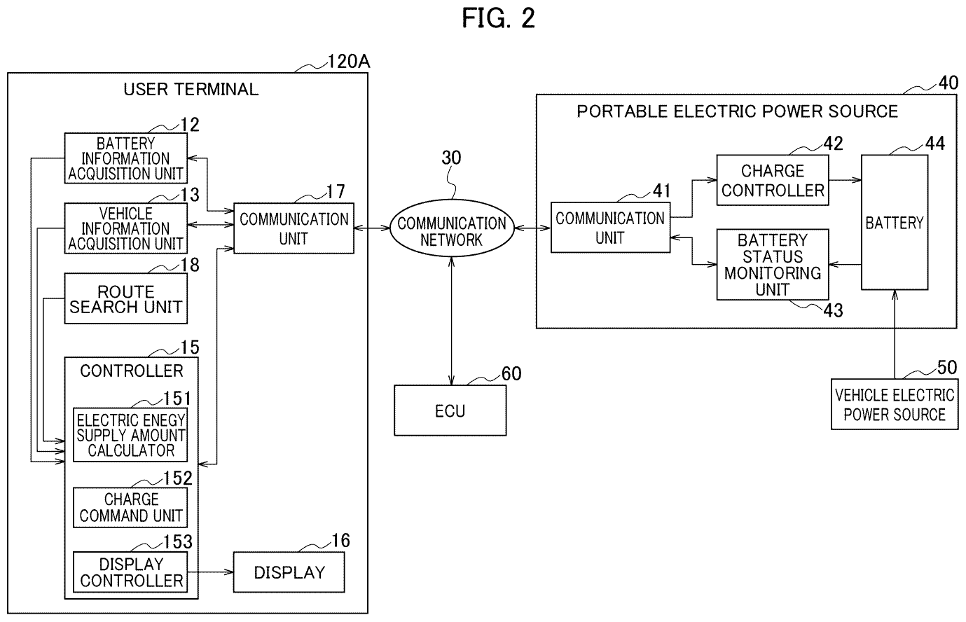

In a modification of a first embodiment illustrated in FIG. 2, the user terminal 10A and the car navigation device 20 in a first embodiment are integrated into a user terminal 120A which monitors the battery 44 of the portable electric power source 40, and commands the charging of the battery 44 as necessary. The user terminal 120A functions as a charge control device. In FIG. 2, the same parts as those in FIG. 1 are denoted by the same reference signs, and further explanation thereof is omitted.

In FIG. 2, the user terminal 120A includes a route search unit 18 including the same function as the route search unit 22 of the car navigation device 20. The route search unit 18 searches a route to a destination and supplies route information to the controller 15 indicating the route to the destination searched by the route search unit 18. The route information includes a time required for a vehicle to arrive at a destination. The battery information acquisition unit 12, the vehicle information acquisition unit 13, and the controller 15 operate in the same manner as those in a first embodiment illustrated in FIG. 1. In the modification of a first embodiment, the route search unit 18 may be implemented as a function by the CPU executing a charge control program, or as a function by the CPU executing a computer program other than the charge control program.

It is also possible to implement functions of the charge control device in the car navigation system 20.

As described above, the user terminal 10A illustrated in FIG. 1 or the user terminal 120A illustrated in FIG. 2 includes the following configuration. When the destination of a vehicle is set and the vehicle is traveling toward a destination, the battery information acquisition unit 12 acquires from the portable electric power source 40 the charging status of the battery 44 of the portable electric power source 40 mounted on the vehicle. The vehicle information acquisition unit 13 acquires at least a piece of information regarding the vehicle electric power source 50 of the vehicle. The vehicle information acquisition unit 13 may acquire the information regarding the vehicle electric power source 50 from the ECU 60 in the vehicle, or may acquire the information regarding the vehicle electric power source 50 from an external database or the like.

Based on the information acquired by the vehicle information acquisition unit 13, the electric energy supply amount calculator 151 calculates an electric energy supply amount that can be supplied from the vehicle electric power source 50 to the portable electric power source 40 without hindering the vehicle from traveling to the destination. When the charge command unit 152 determines that charging of the battery 44 is necessary based on the charging status of the battery 44 acquired from the battery information acquisition unit 12, it commands the charge controller 42 to charge the battery 44 by supplying electric power from the vehicle electric power source 50 to the battery 44 with electric energy equal to or less than the electric energy supply amount.

The vehicle information acquisition unit 13 preferably acquires at least a piece of information regarding traveling of the vehicle, or a piece of information regarding use of electric power consumption devices in the vehicle in addition to a piece of information regarding the vehicle electric power source 50. The electric energy supply amount calculator 151 preferably calculates the electric energy supply amount based on the piece of information regarding the vehicle electric power source, and at least a piece of information regarding traveling of the vehicle or a piece of information regarding the use of the power consumption device.

If the vehicle is an electric vehicle, the information regarding the vehicle electric power source 50 refers to information including a capacity of a battery for driving the electric vehicle, and the remaining charge amount of the battery for driving.

### Operation of Charge Control Device, Charge Control Method, and Charge Control Program according to First Embodiment including Modification

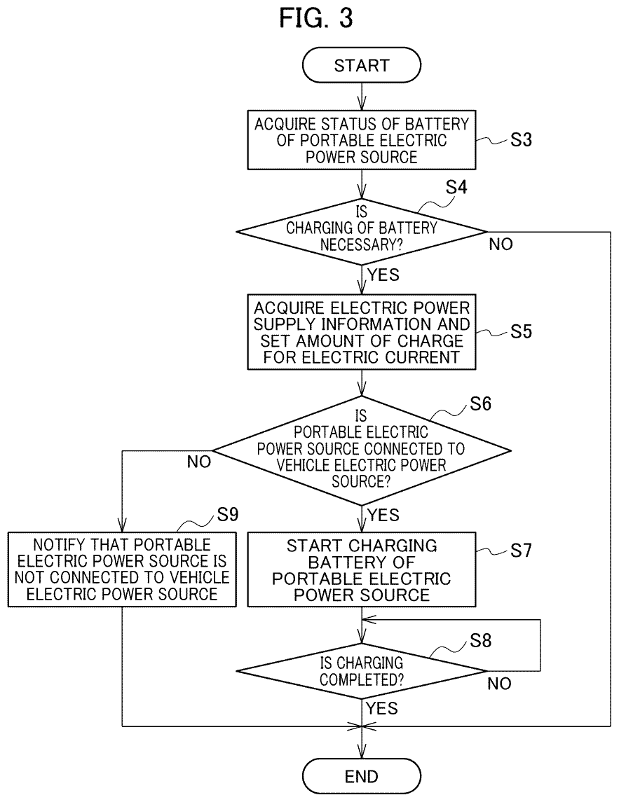

With reference to a flowchart illustrated in FIG. 3, an operation of the charge control device according to a first embodiment, a charge control method according to a first embodiment, and a process which a charge control program according to a first embodiment causes a computer to execute are described.

As illustrated FIG. 3, in step S3, the controller 15 acquires a status of the battery 44 (charging amount) of the portable electric power source 40 when the user terminal 10A or 120A starts operating. In step S4, the controller 15 (charge command unit 152) determines whether or not charging of the battery 44 is necessary. When charging of the battery 44 is not necessary (NO), the controller 15 terminates the process.

When it is determined that charging of the battery 44 is necessary (YES) in step S4, the controller 15 (charge command unit 152) acquires electric power supply information, and sets an amount of charge for electric current in step S5. In step S6, the controller 15 determines whether or not the portable electric power source 40 is connected to the vehicle electric power source 50. When the portable electric power source 40 is not connected to the vehicle electric power source 50 (NO), the controller 15 notifies the user by displaying on the display 16 that the portable electric power source 40 is not connected to the vehicle electric power source 50 in step S9, and the controller 15 terminates the process.

When the portable electric power source 40 is connected to the vehicle electric power source 50 (YES) in step S6, the controller 15 (charge command unit 152) commands the portable electric power source 40 to charge the battery 44 in step S7, causing charging of the battery 44 to start. In step S8, the controller 15 determines whether or not charging of the battery 44 is completed. When charging of the battery 44 is not completed (NO), the controller 15 repeats the process in step S8. When charging of the battery 44 is completed (YES), the controller 15 terminates the process.

FIG. 3 does not illustrate processes of notification of the user by the display 16 when charging of the battery 44 is started in step S7, and when charging of the battery 44 is completed in step S8.

### Second Embodiment

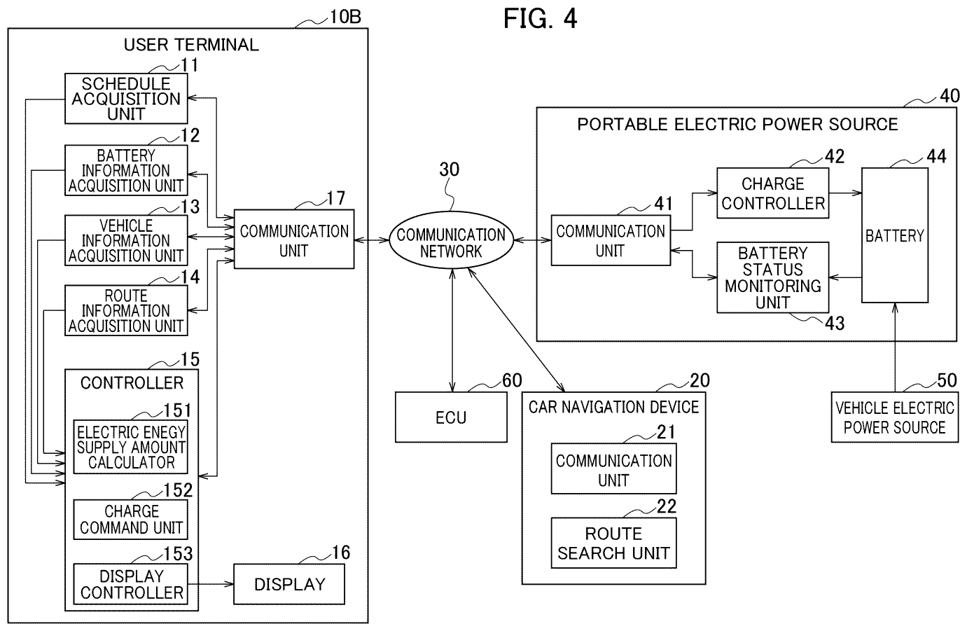

In a second embodiment illustrated in FIG. 4, the same parts as in a first embodiment illustrated in FIG. 1 are denoted by the same reference numerals, and the description thereof may be omitted. In FIG. 4, a user terminal 10B functions as a charge control device according to a second embodiment. The user terminal 10B includes schedule acquisition unit 11, the battery information acquisition unit 12, the vehicle information acquisition unit 13, the route information acquisition unit 14, the controller 15, the display 16, and the communication unit 17.

In the user terminal 10B, the schedule acquisition unit 11 acquires a user's schedule by browsing a schedule table stored in an external cloud or the like through the communication unit 17 and the communication network 30. The schedule acquisition unit 11 may be a schedule management unit for acquiring a user's schedule by the schedule acquisition unit 11 itself managing the schedule of user's actions.

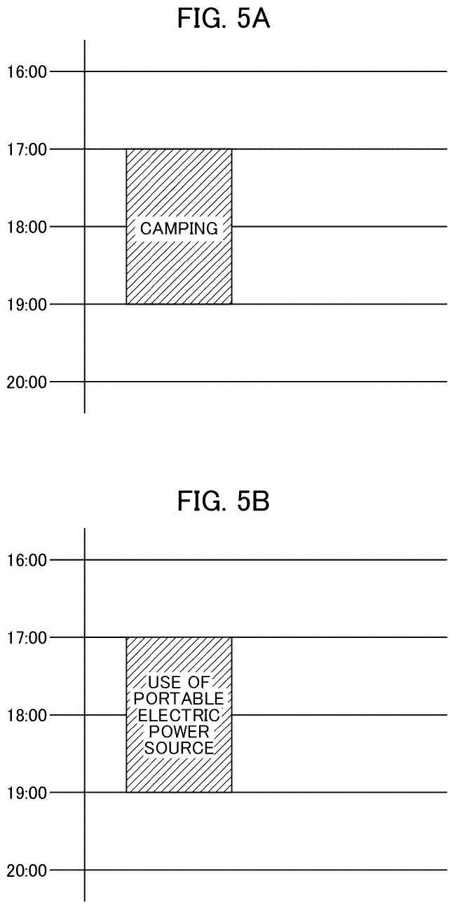

As shown by a first example illustrated in FIG. 5A, camping is scheduled from 5:00 p.m. to 7:00 p.m. on a certain day as a user's schedule. As shown by a second example illustrated in FIG. 5B, the use of the portable electric power source 40 may be scheduled from 5:00 p.m. to 7:00 p.m. on a certain day as a user's schedule. The camping schedule illustrated in FIG. 5A is an example of an event with a possibility of using the portable electric power source 40 on a vehicle. It is assumed that the use of the portable electric power source 40 is planned in the schedule illustrated in FIG. 5A.

The user may be an owner of the user terminal 10B, an owner of the portable electric power source 40, a driver of the vehicle, or an occupant of the vehicle. There may be multiple users. There may be one or more users registered in advance. Schedules of multiple users may be registered in a schedule table illustrated in FIG. 5A or FIG. 5B.

The schedule acquisition unit 11 extracts a schedule in which use of the portable electric power source 40 is set, or an event with a possibility of using the portable electric power source 40 is set, from acquired schedules. When schedules of multiple users are registered in the schedule table, the schedule of at least a user who has the use of the portable electric power source 40 set in the schedule, or a user who has an event with a possibility of using the portable electric power source 40 set, may be extracted.

The schedule acquisition unit 11 may hold a keyword by which the use of the portable electric power source 40 is assumed, and extract a schedule in which the use of the portable electric power source 40 is set or an event with a possibility of using the portable electric power source 40 is set based on the keyword. The keyword may be stored in a memory external to the schedule acquisition unit 11, and the schedule acquisition unit 11 may refer to the keyword stored in the memory. A table with a keyword such as the name of an event with a possibility of using the portable electric power source, the name of a device connected to the portable electric power source, or the like, may be stored in the schedule acquisition unit 11 or in an external memory. When a user registers a schedule, an item to check the use of the portable electric power source 40 may be set.

The schedule acquisition unit 11 may simply acquire all schedules from the schedule table. In this case, the schedule determination unit may determine the schedule acquired by the schedule acquisition unit 11, and extract a schedule in which the use of the portable electric power source 40 is set or an event with a possibility of using the portable electric power source 40 is set. The schedule determination unit may be provided in the user terminal 10B or outside the user terminal 10B.

The schedule determination unit provided outside the user terminal 10B may determine content of a schedule registered in a schedule table stored in an external cloud or the like, and the schedule acquisition unit 11 may acquire only a schedule in which the use of the portable electric power source 40 is set, or an event with a possibility of using the portable electric power source 40 is set.

The battery information acquisition unit 12 acquires a charging status of the battery 44 from the portable electric power source 40 through the communication unit 17 and the communication network 30. The battery information acquisition unit 12 may be configured to acquire the charging status of the battery 44 when the use of the portable electric power source 40 is scheduled based on the schedule illustrated in FIG. 5A or FIG. 5B. Even when the use of the portable electric power source 40 is not directly set as illustrated in FIG. 5A, the schedule acquisition unit 11 (or the schedule determination unit) may determine that the portable electric power source 40 may be used.

The operations of the vehicle information acquisition unit 13 and the route information acquisition unit 14 are the same as those of a first embodiment. The user's schedule acquired by the schedule acquisition unit 11, the charging status of the battery 44 acquired by the battery information acquisition unit 12, at least a piece of information regarding the vehicle electric power source acquired by the vehicle information acquisition unit 13, or a piece of route information acquired by the route information acquisition unit 14, is input to the controller 15. The user's schedule input to the controller 15 is a schedule in which the use of the portable electric power source 40 is set, or an event with a possibility of using the portable electric power source 40 is set.

The operation of the electric energy supply amount calculator 151 is the same as that in a first embodiment. When use of the portable electric power source 40 is set, or an event with a possibility of using the portable electric power source 40 is set based on the schedule acquired by the schedule acquisition unit 11, the charge command unit 152 commands the charge controller 42 to charge the battery 44, as necessary.

The charge command unit 152 determines whether charging of the battery 44 is necessary based on the charging status of the battery 44 acquired from the battery information acquisition unit 12. When the charge command unit 152 determines that charging of the battery 44 is necessary, it commands the charge controller 42 to start charging the battery 44 through the communication unit 17, the communication network 30, and the communication unit 41. At this point, the charge command unit 152 commands the charge controller 42 to command charging of the battery 44 by supplying electric power from the vehicle electric power source 50 to the battery 44 of the portable electric power source 40 with an electric energy amount equal to or less than the electric energy supply amount calculated by the electric energy supply amount calculator 151, thereby charging the battery 44.

The charge command unit 152 may determine that charging of the battery 44 is necessary when the battery 44 is not fully charged, or may determine that charging of the battery 44 is necessary when the amount of charge of the battery 44 is less than a predetermined amount of charge.

The charge command unit 152 may calculate a required electric energy amount of the portable electric power source 40 required at the destination based on a time period of an event with a possibility of using the portable electric power source 40, as illustrated in FIG. 5A, or based on a time period for which the use of the portable electric power source 40 is set, as illustrated in FIG. 5B. The charge command unit 152 may calculate the required electric energy amount of the portable electric power source 40, and determine that charging of the battery 44 is necessary when the amount of charge of the battery 44 is less than the required electric energy amount.

When only an event is set in the schedule as illustrated in FIG. 5A, the required electric energy amount of the portable electric power source 40 required at the destination is not known exactly, but the required electric energy amount can be calculated with some accuracy by assuming the electric energy amount to be used. The same applies to the schedule illustrated in FIG. 5B. As a third example of the schedule, an electric device to be used with the portable electric power source 40 may be set. For example, when a hot plate is set to be used from 5:00 p.m. to 7:00 p.m., the charge command unit 152 can calculate the electric energy amount to be used with high accuracy.

Thus, when the use of the portable electric power source 40 is set based on the schedule acquired by the schedule acquisition unit 11, or when an event with a possibility of using the portable electric power source 40 is set based on the schedule acquired by the schedule acquisition unit, the charge command unit 152 determines whether charging of the battery 44 is necessary based on the charging status of the battery 44 acquired by the battery information acquisition unit 12. When the charge command unit 152 determines that charging of the battery 44 is necessary, it commands the charge controller 42 to charge the battery 44 by supplying electric power from the vehicle electric power source 50 to the battery 44 through the communication unit 17, the communication network 30, and the communication unit 41.

The charge command unit 152 may calculate the required electric energy amount of the portable electric power source 40 required at the destination based on the information of a device that is connected to the portable electric power source 40, and is operating with the power supplied from the portable electric power source 40. When the amount of charge of the battery 44 is determined to be less than the required electric energy amount based on the charging status of the battery 44 acquired by the battery information acquisition unit 12, the charge command unit 152 may command the portable electric power source 40 to charge the battery 44 at least until the required electric energy amount is satisfied. The charge command unit 152 may command the portable electric power source 40 to fully charge the battery 44 as long as the battery 44 can be charged at or below the electric energy supply amount.

As described above, with the user terminal 10B functioning as the charge control device, the portable electric power source 40 can be automatically charged when the portable electric power source 40 mounted on the vehicle is not charged or is not fully charged despite the fact that the use of the portable electric power source 40 is set, or an event with a possibility of using the portable electric power source 40 is set.

The schedule acquisition unit 11, the battery information acquisition unit 12, the vehicle information acquisition unit 13, the route information acquisition unit 14, the electric energy supply amount calculator 151, the charge command unit 152, and the display controller 153 may be implemented as functions by the CPU executing a charge control program which is a computer program. The charge control program is stored in a non-temporary storage medium provided in the user terminal 10B, and the CPU executes the charge control program.

### Modification of Second Embodiment

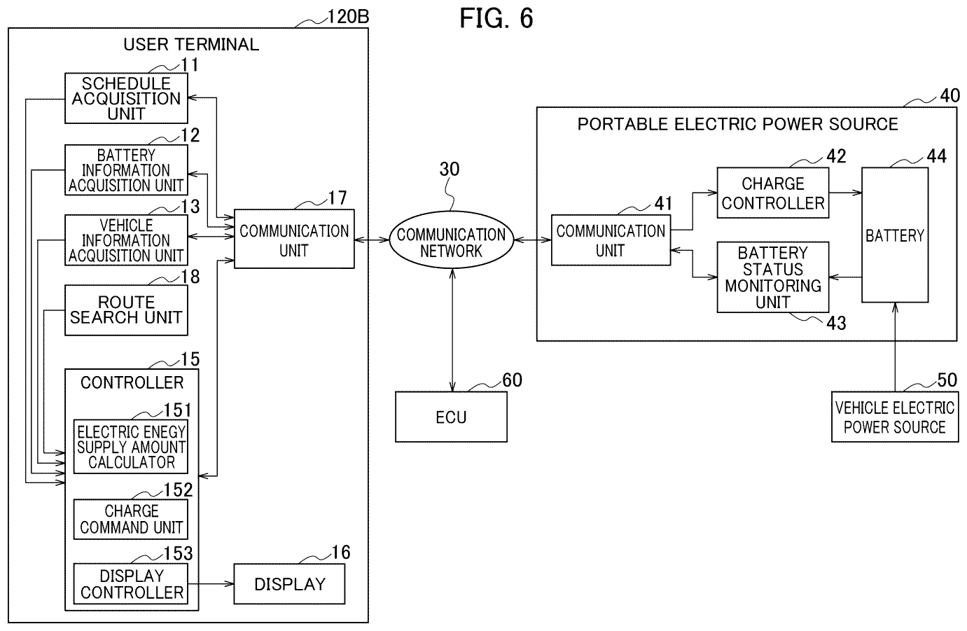

In a modification of a second embodiment illustrated in FIG. 6, the user terminal 10B and the car navigation device 20 are integrated in the user terminal 120B which monitors the battery 44 of the portable electric power source 40, and commands the charging of the battery 44, as necessary. The user terminal 120B functions as a charge control device. In FIG. 6, the same parts as those in FIG. 4 are denoted by the same reference signs, and further explanation thereof is omitted.

In FIG. 6, the user terminal 120A includes the route search unit 18 including the same function as the route search unit 22 of the car navigation device 20. The route search unit 18 supplies route information indicating a route to a destination searched by the route search unit 18 to the controller 15. The route information includes a time required for a vehicle to arrive at a destination. The schedule acquisition unit 11, the battery information acquisition unit 12, the vehicle information acquisition unit 13, and the controller 15 operate in the same manner as those in a second embodiment illustrated in FIG. 4. In the modification of a second embodiment, the route search unit 18 may be implemented as a function by the CPU executing a charge control program, or as a function by the CPU executing a computer program other than the charge control program.

It is also possible to implement functions of the charge control device in the car navigation device 20, and to configure the car navigation device 20 to acquire the user's schedule from the user terminal.

As described above, the user terminal 10B illustrated in FIG. 4, or the user terminal 120B illustrated in FIG. 6. includes a configuration as follows. The schedule acquisition unit 11 acquires the user's schedule. The battery information acquisition unit 12 acquires a charging status of the battery 44 included in the portable electric power source 40 from the portable electric power source 40.

The charge command unit 152 determines whether charging of the battery 44 is necessary based on the charging status of the battery 44 acquired by the battery information acquisition unit 12 when the use of the portable electric power source 40 is set! based on the schedule acquired by the schedule acquisition unit 11, or an event with a possibility of using the portable electric power source 40 is set. When the charge command unit 152 determines that charging of the battery 44 is necessary, it commands the charge controller 42 to charge the battery 44 by supplying electric power from the vehicle electric power source 50 to the battery 44.

The charge command unit 152 preferably calculates required electric energy amount which is required by the portable electric power source 40 at a destination based on information of a device which is connected to the portable electric power source 40 and operating with electric power supplied from the portable electric power source 40. The charge command unit 152 may command the portable electric power source 40 to charge the battery 44 to at least satisfy the required electric energy amount when it is determined that an amount of charge of the battery 44 is less than the required electric energy amount, based on the charging status of the battery 44 acquired by the battery information acquisition unit 12.

Preferably, the charge command unit 152 provides commands so that the battery 44 is charged at a charging speed corresponding to the time required for a vehicle to arrive at a destination. The charge controller 42 may be commanded to charge the battery 44 at a charging speed selected from at least two charging speeds so that the charging speed for charging the battery 44 becomes slower as the time required for a vehicle to arrive at a destination increases, and the charging speed becomes faster as the time required for a vehicle to arrive at a destination decreases.

### Operation of Charge Control Device, Charge Control Method, and Charge Control Program according to Second Embodiment including Modification

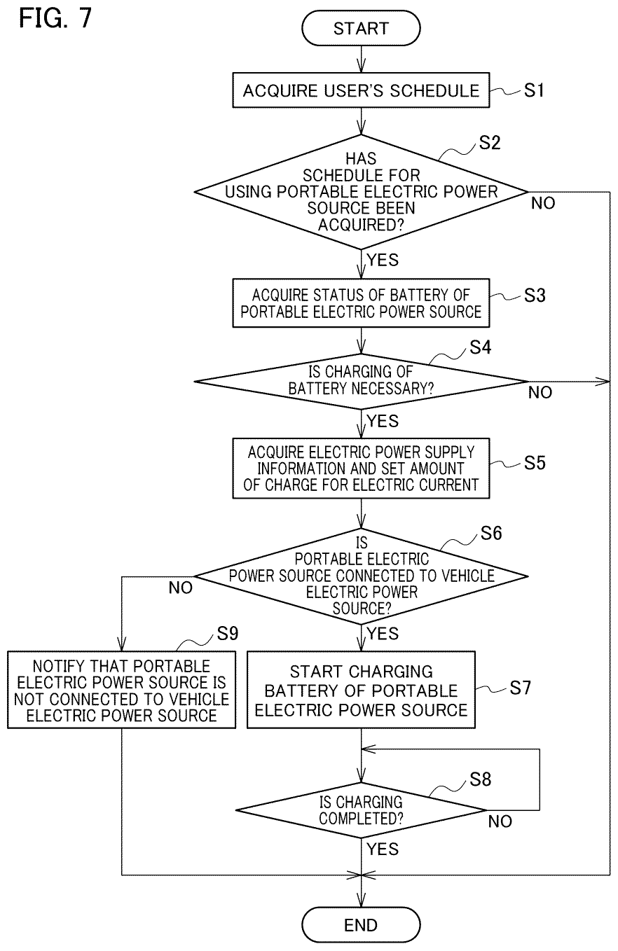

With reference to a flowchart illustrated in FIG. 7, an operation of the charge control device according to a second embodiment, a charge control method according to a second embodiment, and a process which the charge control program according to a second embodiment causes a computer (CPU) to execute will be described.

In FIG. 7, when the user terminal 10B or 120B starts operation, the schedule acquisition unit 11 acquires the user's schedule in step S1. In step S2, the controller 15 determines whether or not the schedule for using the portable electric power source 40 has been acquired from the schedule acquisition unit 11. If the schedule for using the portable electric power source 40 has not been acquired (NO), the controller 15 terminates the process.

When the schedule for using the portable electric power source 40 has been acquired (YES) in step S2, the controller 15 acquires a status of the battery 44 (amount of charge) of the portable electric power source 40 in step S3. In step S4, the controller 15 (charge command unit 152) determines whether or not charging of the battery 44 is necessary. When charging of the battery 44 is not necessary (NO), the controller 15 terminates the process.

When it is determined that charging of the battery 44 is necessary (YES) in step S4, the controller 15 (charge command unit 152) acquires electric power supply information, and sets an amount of charge for electric current in step S5. In step S6, the controller 15 determines whether or not the portable electric power source 40 is connected to the vehicle electric power source 50. When the portable electric power source 40 is not connected to the vehicle electric power source 50 (NO), the controller 15 notifies the user by displaying on the display 16 that the portable electric power source 40 is not connected to the vehicle electric power source 50 in step S9, and the controller 15 terminates the process.

When the portable electric power source 40 is connected to the vehicle electric power source 50 (YES) in step S6, the controller 15 (charge command unit 152) commands the portable electric power source 40 to charge the battery 44 to start charging the battery 44 in step S7. In step S8, the controller 15 determines whether or not the charging of the battery 44 is completed. When the charging of the battery 44 is not completed (NO), the controller 15 repeats the process in step S8. When the charging of the battery 44 is completed (YES), the controller 15 terminates the process.

In FIG. 7, the process of notifying the user by the display 16 when the charging of the battery 44 is started in step S7, and when the charging of the battery 44 is completed in step S8, is omitted.

### Advanced Configuration Example

In the first and second embodiments described above, the status of the battery 44 is checked when the vehicle travels toward the destination, but it is also possible to check the status of the battery 44 at any timing before the vehicle travels.

The battery information acquisition unit 12 acquires required electric energy amount for an event set in the schedule according to the schedule of the user acquired by the schedule acquisition unit 11, and acquires a charging status of the battery 44 from the portable electric power source 40. When charging of the battery 44 is necessary, the controller 15 calculates a traveling time of the vehicle required for charging. When the traveling time to the destination is shorter than the traveling time of the vehicle required for charging, the display controller 153 notifies the user by displaying it on the display 16.

The present invention is not limited to first or second embodiment described above, and can be modified in various ways without departing from the scope of the present invention.

What is claimed is:

1. A charge control device comprising:
a battery information acquisition unit configured to acquire a charging status of a battery of a portable electric power source from the portable electric power source, the portable electric power source being mounted on a vehicle for which a destination is set;
a vehicle information acquisition unit configured to acquire at least a piece of information regarding the vehicle electric power source included in the vehicle;
an electric energy supply amount calculator configured to calculate, based on the information acquired by the vehicle information acquisition unit, an electric energy supply amount that can be supplied from the vehicle electric power source to the portable electric power source without hindering the vehicle from traveling to the destination; and
a charge command unit configured to command the charge controller included in the portable electric power source to charge the battery by supplying electric power from the vehicle electric power source to the battery with an electric energy amount equal to or less than the electric energy supply amount when determining charging of the battery is necessary based on the charging status of the battery acquired from the battery information acquisition unit.

2. The charge control device according to claim 1, wherein
the vehicle information acquisition unit is configured to acquire at least a piece of information regarding traveling of the vehicle, or a piece of information regarding use of an electric power consumption device in the vehicle, in addition to the piece of the information regarding the vehicle electric power source, and
the electric c energy supply amount calculator is configured to calculate the electric energy supply amount based on the piece of information regarding the vehicle electric power source, and at least the piece of information regarding the traveling of the vehicle or the piece of information regarding the use of the electric power consumption device.

3. The charge control device according to claim 1, wherein when the vehicle is an electric vehicle, the piece of information regarding the vehicle electric power source includes a capacity of a battery for driving included in the electric vehicle, and a remaining charge amount of the battery for driving.

4. A charge control method comprising:
acquiring a charging status of a battery of a portable electric power source from the portable electric power source, the portable electric power source being mounted on a vehicle for which a destination is set;
acquiring at least a piece of information regarding the vehicle electric power source included in the vehicle;
calculating, based on the acquired information, an electric energy supply amount that can be supplied from the vehicle electric power source to the portable electric power source without hindering the vehicle from traveling to the destination; and
commanding the charge controller included in the portable electric power source to charge the battery by supplying electric power from the vehicle electric power source to the battery with an electric energy amount equal to or less than the electric energy supply amount when determining that charging of the battery is necessary based on the acquired charging status of the battery.

5. A charge control device comprising:
a schedule acquisition unit configured to acquire a user's schedule;
a battery information acquisition unit configured to acquire a charging status of a battery of a portable electric power source from the portable electric power source, the portable electric power source being mounted on a vehicle for which a destination is set; and
a charge command unit configured to command the charge controller included in the portable electric power source to charge the battery by supplying electric power from the vehicle electric power source included in the vehicle when determining that charging of the battery is necessary, based on the charging status of the battery acquired by the battery information acquisition unit, when use of the portable electric power source is set, or when an event with a possibility of using the portable electric power source is set based on the schedule acquired by the schedule acquisition unit.

6. The charge control device according to claim 5, wherein
the charge command unit is configured
to calculate a required electric energy amount for the portable electric power source required at the destination based on information of a device that is connected to the portable electric power source, and operating with electric power supplied from the portable electric power source, and
to command the portable electric power source to charge the battery to at least satisfy the required electric energy amount when it is determined that the amount of charge of the battery is less than the required electric energy amount, based on the charging status of the battery acquired by the battery information acquisition unit.

7. The charge control device according to claim 5, wherein the charge command unit is configured to command the charge control device to charge the battery at a charging speed corresponding to a time required for a vehicle to arrive at a destination.
